(19) United States
(12) Patent Application Publication
(10) Pub. No.: US 2012/0219725 A1
(43) Pub. Date: Aug. 30, 2012

(54) Substrate Processing Apparatus And Method

(75) Inventors: Andrea Baccini, Mignagola Di Carbonera (IT); Giorgio Cellere, Torri Di Quartesolo (vi) (IT); Luigi De Santi, Spresiano (IT); Marco Galiazzo, Padova (pd) (IT); Gianfranco Pasqualin, Spresiano (IT); Tommaso Vercesi, Treviso (IT)

(73) Assignee: APPLIED MATERIALS, INC., Santa Clara, CA (US)

(21) Appl. No.: 13/394,126

(22) PCT Filed: Sep. 2, 2010
(86) PCT No.: PCT/EP2010/062850

§ 371 Date: May 14, 2012

(30) Foreign Application Priority Data
Sep. 3, 2009 (IT) UD2009A000157

(51) Int. Cl. B05D 5/00; B05C 9/12; B05D 3/06; B05D 3/00; B05D 3/02; B05C 11/00; B05C 9/14

(52) U.S. Cl. 427/542; 118/712; 427/256; 427/557; 427/555; 427/271

(57) ABSTRACT

An apparatus for processing a substrate includes an inspection system disposed in a first position to detect the location and orientation of the substrate supported on a supporting surface of a processing nest positioned in the first position and one or more processing heads disposed in the second and third positions and configured to perform a first and a second process on the substrate when the processing nest is moved to the second and third positions by an actuator assembly. A method for processing a substrate includes detecting the location and orientation of the substrate disposed on the processing nest which is positioned in the first position and aligning one or more processing heads to the substrate when the processing nest is positioned in the second and third positions and under the processing heads using data detected by an inspection system positioned in the first position.

### CROSS-REFERENCE TO RELATED APPLICATIONS

This application claims benefit of International Patent Application Serial No. PCT/EP2010/062850 filed Sep. 2, 2010, which claims the benefit of Italian Patent Application Serial Number UD2009A000157, filed Sep. 3, 2009, all of which are herein incorporated by reference.

### FIELD OF THE INVENTION

Embodiments of the present invention generally relate to an apparatus and method for moving, aligning, and processing a substrate. In particular, embodiments of the present invention may be used to accurately deposit and subsequently process a patterned layer on a substrate.

### BACKGROUND OF THE INVENTION

Solar cells are photovoltaic (PV) devices that convert sunlight directly into electrical power. Solar cells typically have one or more p-n junctions. Each p-n junction comprises two different regions within a semiconductor material where one side is denoted as the p-type region and the other as the n-type region. When the p-n junction of a solar cell is exposed to sunlight (consisting of energy from photons), the sunlight is directly converted to electricity through the PV effect. Solar cells generate a specific amount of electric power and are tiled into modules sized to deliver the desired amount of system power. Solar modules are joined into panels with specific frames and connectors. Solar cells are commonly formed on silicon substrates, which may be single or multicrystalline silicon substrates. A typical solar cell includes a silicon wafer, substrate, or sheet typically less than about 0.3 mm thick with a thin layer of n-type silicon on top of a p-type region formed on the substrate.

The PV market has experienced growth at annual rates exceeding 30% for the last ten years. Some articles suggest that solar cell power production world-wide may exceed 10 GWp in the near future. It is estimated that more than 95% of all solar modules are silicon wafer based. The high market growth rate in combination with the need to substantially reduce solar electricity costs has resulted in a number of serious challenges for inexpensively forming high quality solar cells. Therefore, one major component in making commercially viable solar cells lies in reducing the manufacturing costs required to form the solar cells by improving the device yield and increasing substrate throughput in a solar cell fabrication process.

Screen and ink jet printing have been used in printing designs on objects, such as cloth or ceramics, and are used in the electronics industry for printing electrical component patterns, such as electrical contacts or interconnects on a surface of a substrate. State of the art solar cell fabrication processes also use screen and ink jet printing processes. In these processes, the production throughput is limited by the amount of time used in moving and printing a pattern on a single substrate. One method of increasing throughput is by printing a pattern on more than one substrate at a time via a single print head. However, current methods fail to provide consistent pattern alignment on each individual substrate, which can lead to poor device performance and low device efficiency.

Therefore, there is a need for an apparatus for the production of solar cells, electronic circuits, or other useful devices that has an improved method of controlling the movement and alignment of substrates within a substrate processing system.

### SUMMARY OF THE INVENTION

In one embodiment of the present invention, an apparatus for processing a substrate comprises: means to support said substrate; input means able to position said support means in a first loading position; inspection means able to detect location and orientation data of the substrate disposed on said support means in said first position; at least a first processing head able to perform, in a second processing position, a first process on said substrate disposed on said support means; at least a second processing head able to perform, in a third processing position, a second process, different from said first process, on said substrate disposed on said support means; movement means able to move said support means at least from said first position to said second position and between said second position and third position.

According to an aspect of the present invention, the support means and the at least one second processing head are reciprocally configured so as to keep said substrate on the same support means during the second process also.

According to other embodiments of the invention, a substrate processing method comprises: an operation to transfer the substrate; an operation to load the substrate on support means in a first position; a single inspection operation able to detect location and orientation data of the substrate disposed on said support means in said first position; moving operations able at least to position the support means with the substrate in a second position in correspondence with at least a first processing head; an alignment operation able to align the reciprocal position between at least said first processing head and the substrate disposed on said support means in said second position, according to the data detected in said single inspection operation; a first processing operation able to perform, by means of said at least one first processing head in said second position, a first process on the substrate disposed on said support means in said second position; a third moving operation able to move the support means, disposed in the second position, toward a third position in correspondence with at least a second processing head and to move the support means, already disposed in said third position, toward the second position in correspondence with said at least one first processing head where both said alignment operation, only according to the data detected in said single inspection operation, and said first processing operation are repeated; a second processing operation able to perform, in said third position by means of said second processing head, a second processing operation on the substrate disposed on said support means, said second process being different from said first process; a fourth moving operation able to move the support means from said second position to said third position, where said second processing operation is repeated, and able to move the support means, already subjected to the repetition of said second processing operation, from the third position to an exit position.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic isometric view of a processing system according to one embodiment of the present invention.

FIG. 2 is a schematic plan view of the system depicted in FIG. 1.

FIG. 3 is a schematic isometric view of an actuator assembly according to one embodiment of the present invention.

FIG. 4 is a schematic diagram of an operating sequence according to embodiments of the present invention.

FIGS. 5A-5C are schematic plan views of the system illustrating the operational sequence of FIG. 4 according to embodiments of the present invention.

FIG. 6 is a schematic plan view of an alternative embodiment of the present invention.

FIG. 7 is a schematic diagram of an operational sequence according to alternative embodiments of the present invention.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention provide an apparatus and method for processing substrates in a processing system that has an increased system throughput, improved system uptime, and improved device yield performance, while maintaining a repeatable and accurate substrate processing. In one embodiment, the processing system is adapted to perform a screen or ink jet printing process within a portion of a crystalline silicon solar cell production line in which a substrate is patterned with a desired material, and is then processed in one or more subsequent processing chambers.

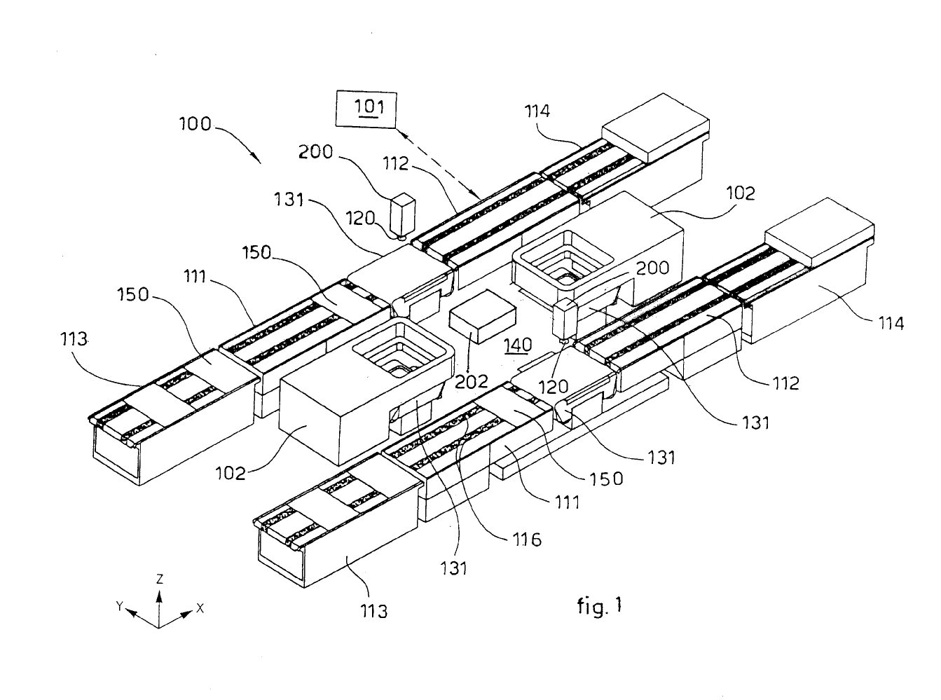

FIG. 1 is a schematic isometric view of a substrate processing system, or system 100, according to one embodiment of the present invention. In one embodiment, which provides to use two parallel processing lines, the system 100 generally includes two incoming conveyors 111, an actuator assembly 140, a plurality of processing nests 131, a plurality of processing heads 102, 202, of which two first processing heads 102 able to perform a first type of process on the substrate and at least a second processing head 202 able to perform a second type of process on the substrate, different from the first type of process, two outgoing conveyors 112, and a system controller 101. The incoming conveyors 111 are configured in a parallel processing configuration so that each can receive unprocessed substrates 150 from an input device, such as an input conveyor 113, and transfer each unprocessed substrate 150 to a processing nest 131 coupled to the actuator assembly 140. Additionally, the outgoing conveyors 112 are configured in parallel so that each can receive a processed substrate 150 from a processing nest 131 and transfer each processed substrate 150 to a substrate removal device, such as an exit conveyor 114.

In one embodiment, substrates 150 are microcrystalline silicon substrates used for processing solar cells thereon. In another embodiment, substrates 150 are green tape ceramic substrates or the like.

In one embodiment of the present invention, the system 100 is a processing system able to perform sequences of different operations on the substrates, such as for example multiple operations of screen printing and drying the printed material.

In one embodiment of the present invention, the first processing heads 102 include screen printing components, which are configured to screen print a patterned layer of material on a substrate 150. In another embodiment, the system 100 is an ink jet printing system and the first processing heads 102 include ink jet printing components, which are configured to deposit a patterned layer of material on a substrate 150.

Another embodiment provides that one of the two first processing heads 102 is configured for screen printing and another of the two first processing heads 102 is configured for ink jet printing.

According to another embodiment, the second processing head 202 includes components configured to function as a laser drying unit to dry the layer of material printed by the first processing heads. Alternatively, by suitably varying the print material used, drying can be done by means of UV light or a beam of electrons or other heat energy sources that do not subject the processing nest to heat stresses which may cause damage to the various associated components, and which therefore do not need to adopt a specific and different processing nest and hence to move the substrate 150 from one processing nest to another.

According to another embodiment, one of the processing heads 102, 202, or another module for processing the substrate (not shown in the drawings), is able to perform material removal processes on the substrate, such as laser ablation or etching on one or more regions of a substrate or on layers of material previously deposited with one of the printing and deposit technologies as indicated above.

In other embodiments, the system 100 may comprise other substrate processing modules which require precise movement and positioning of the substrates for processing. For example, a third processing head may be provided, not shown in the drawings, able to perform the screen printing of said print material, or a different print material, on said substrate.

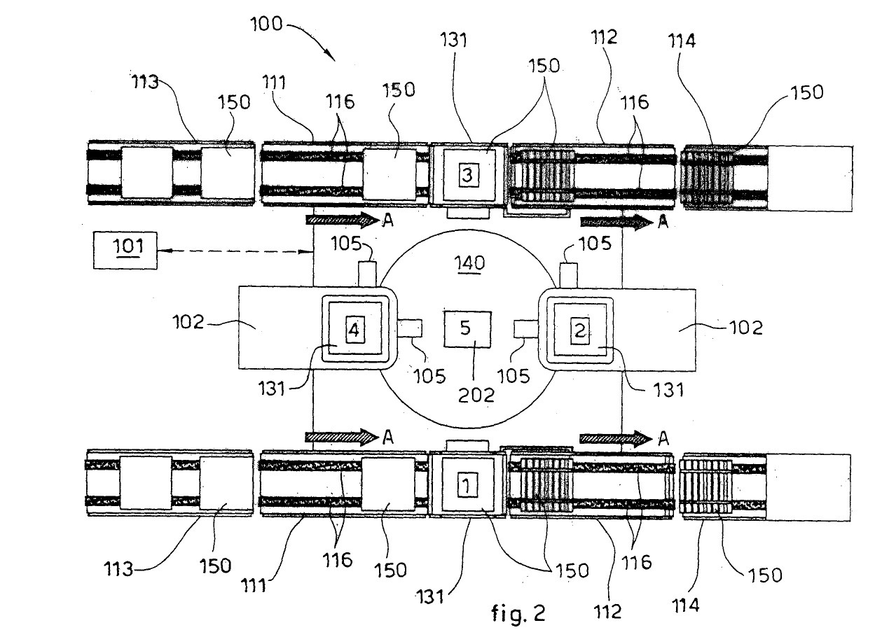

FIG. 2 is a schematic plan view of the system 100 depicted in FIG. 1. FIGS. 1 and 2 illustrate the system 100 having two processing nests 131 (in first positions “1” and “3”) each positioned to both transfer a processed substrate 150 to the outgoing conveyor 112 and receive an unprocessed substrate 150 from the incoming conveyor 111. Thus, in the system 100, the substrate motion generally follows the path “A” shown in FIG. 2. In this configuration, each of the other two processing nests 131 (in second processing positions “2” and “4”) is respectively positioned under the first processing head 102 and the second processing head 202, so that the first process, for example screen printing of a first layer of print material, can be performed on the unprocessed substrates 150 situated on the respective processing nests 131 in correspondence with the first processing heads 102.

The second process, different from and subsequent to the first, for example laser drying, is performed on the processed substrates 150 in correspondence with the second processing head 202.

In order to perform multiple printing, the processed substrates 150 subjected to the second process, for example laser or UV drying, are again positioned under the relative first processing heads 102, to perform a second printing of a second layer of print material on the substrate 150.

By using two processing heads 102 it is possible to perform the second printing operation according to a different pattern from what was done in the first printing operation.

Subsequently, the substrate 150 can be subjected to a second process, such as laser drying, or laser heating, of the second layer of printed print material and the cycle can continue a desired number of times, according to the number of layers of print material to be printed one above the other. The cycle can be performed in parallel for several substrates 150 fed by the two parallel processing lines. The second process, for example laser drying, may be such that it can be performed simultaneously on several processed substrates 150, thus optimizing working times. In fact, after a first and a second substrate 150 have been printed, under the respective processing heads 102, they can be simultaneously subjected to the second process, for example laser drying, and then again the second layer of print material can be printed on them and so on.

Although the system 100 is depicted having two processing heads 102 and four processing nests 131, the system 100 may comprise additional first processing heads 102 and/or processing nests 131 and/or additional second processing heads 202 without departing from the scope of the present invention.

In one embodiment, the incoming conveyor 111 and outgoing conveyor 112 include at least one belt 116 to support and transport the substrates 150 to a desired position within the system 100 by use of an actuator (not shown) that is in communication with the system controller 101. While FIGS. 1 and 2 generally illustrate a substrate transferring system with two belts 116, other types of transferring mechanisms may be used to perform the same substrate transferring and positioning functions without varying from the basic scope of the invention.

In one embodiment, the system 100 also includes an inspection system 200, which is adapted to locate and inspect the substrates 150 at least before processing has been performed, advantageously also after. The inspection system 200 may include one or more cameras 120 that are positioned to inspect a substrate 150 positioned in the loading/unloading positions “1” and “3,” as shown in FIGS. 1 and 2. The inspection system 200 generally includes at least one camera 120 (e.g., CCD camera) and other electronic components that are able to locate, inspect, and communicate the results to the system controller 101. In one embodiment, the inspection system 200 locates the position of certain features of an incoming substrate 150 and communicates the inspection results to the system controller 101 for analysis of the orientation and position of the substrate 150 to assist in the precise positioning of the substrate 150 under a processing head 102 prior to processing the substrate 150. In one embodiment, the inspection system 200 inspects the substrates 150 so that damaged or mis-processed substrates can be removed from the production line. In one embodiment, the processing nests 131 may each contain a lamp, or other similar optical radiation device, to illuminate the substrate 150 positioned thereon so that it can be more easily inspected by the inspection system 200.

The system controller 101 facilitates the control and automation of the overall system 100 and may include a central processing unit (CPU) (not shown), memory (not shown), and support circuits (or I/O) (not shown). The CPU may be one of any form of computer processors that are used in industrial settings for controlling various chamber processes and hardware (e.g., conveyors, detectors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 101 determines which tasks are performable on a substrate. Preferably, the program is software readable by the system controller 101, which includes code to generate and store at least substrate positional information, the sequence of movement of the various controlled components, substrate inspection system information, and any combination thereof.

In one embodiment, the two first processing heads 102 utilized in the system 100 may be conventional screen printing heads available from Applied Materials Italia Srl which are adapted to deposit material in a desired pattern on the surface of a substrate 150 disposed on a processing nest 131 in position “2” or “4” during a screen printing process. In one embodiment, each first processing head 102 includes a plurality of actuators, for example, actuators 105 (e.g., stepper motors or servomotors) that are in communication with the system controller 101 and are used to adjust the position and/or angular orientation of a screen printing mask (not shown) disposed within the each first processing head 102 with respect to the substrate 150 being printed. In one embodiment, the screen printing mask is a metal sheet, net or plate that has a plurality of features, such as holes, slots, or other apertures formed therethrough to define a pattern and placement of screen printed material (i.e., ink or paste) on a surface of a substrate 150.

In general, the screen printed pattern that is to be deposited on the surface of a substrate 150 is aligned to the substrate 150 in an automated fashion by orienting the screen printing mask using the actuators 105 and information received by the system controller 101 from the inspection system 200.

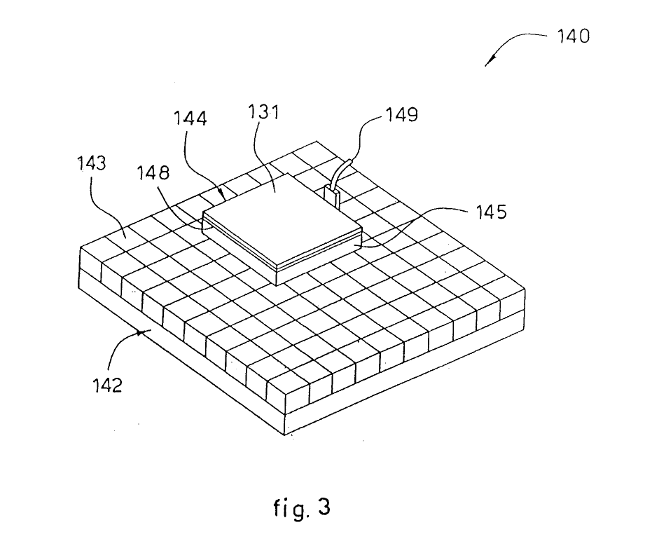

FIG. 3 is a schematic isometric view of an actuator assembly 140 according to one embodiment of the present invention. In one embodiment, the actuator assembly 140 is a planar motor comprising a stator 142 and one or more movers 144. The stator 142 may include a permanent magnet part 143 having a plurality of S-pole permanent magnets and N-pole permanent magnets arranged in a grid form. The mover 144 may include an armature coil part 145, which receives an electric signal via cables 149. When an electric signal is applied to the armature coil part 145, a thrust is generated between the armature coil part 145 of the mover 144 and the permanent magnet part 143 of the stator 142.

In one embodiment of the present invention, each mover 144 has a respective processing nest 131 coupled thereto. In such an embodiment, the actuator assembly 140 is capable of precise X-Y movement and positioning of each processing nest 131 via signals sent through cables 149 from the system controller 101.

In one embodiment, each of the processing nests 131 is affixed to a rotary actuator 148 (FIG. 3), which is positioned between and coupled to the processing nest 131 and its respective mover 144 for precisely positioning each of the processing nests 131 at an angle with respect to the respective mover 144.

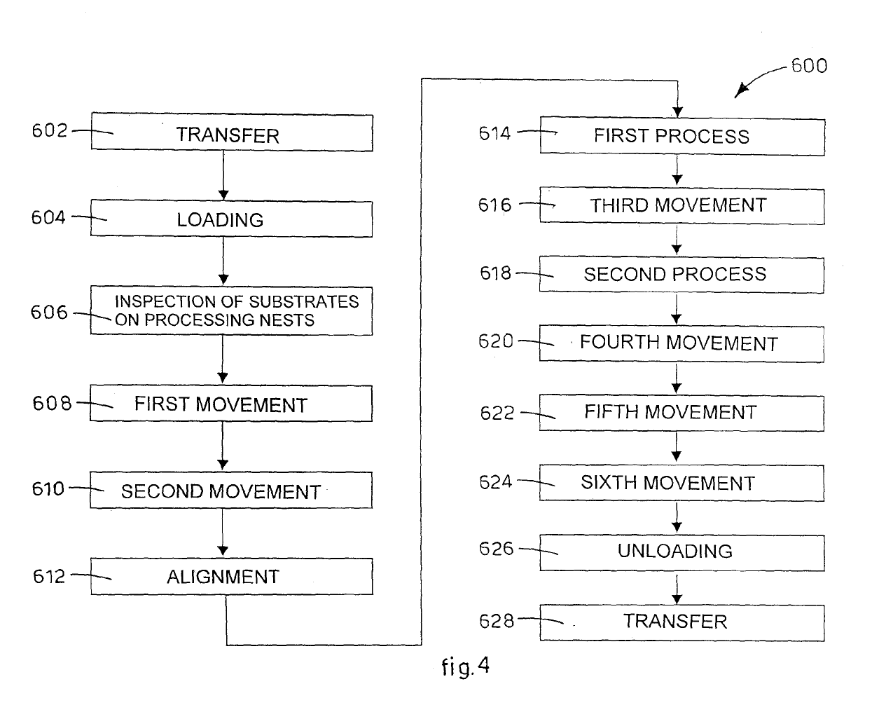

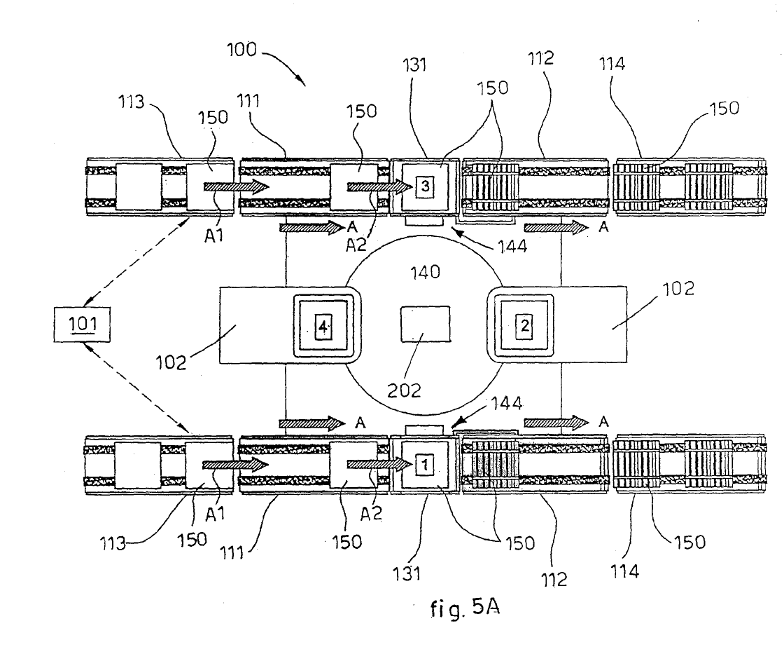

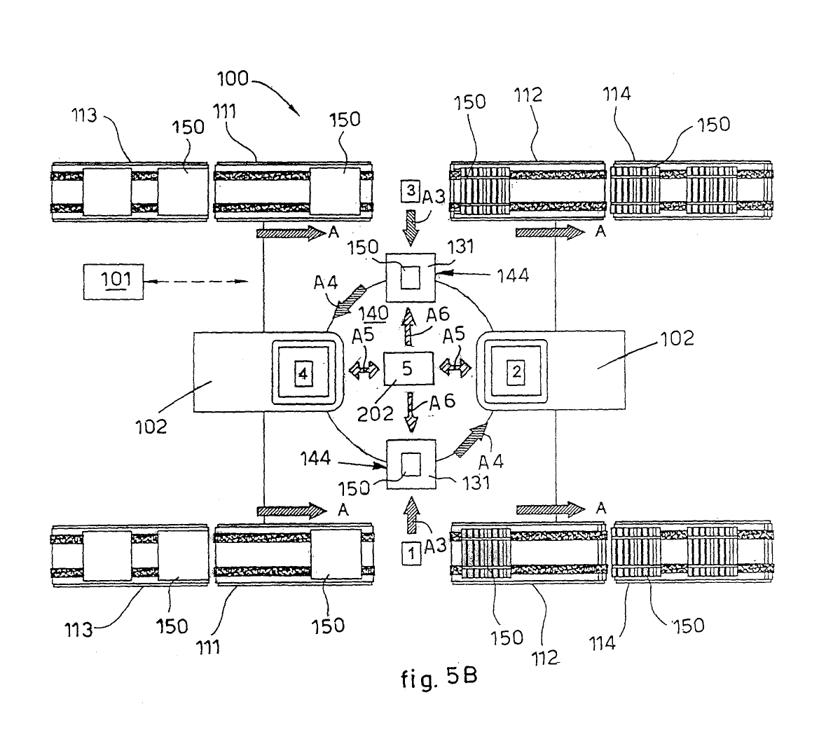

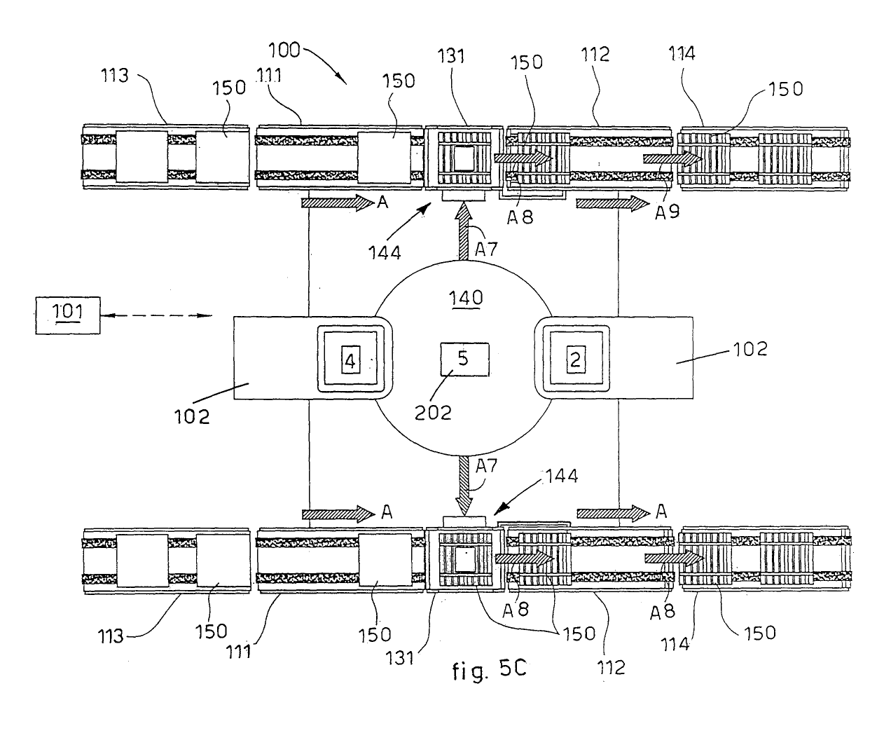

FIG. 4 is a schematic diagram of an operational sequence 600, according to embodiments of the present invention. FIGS. 5A-5C are schematic plan views of the system 100 showing the operational sequence 600 according to embodiments of the present invention.

In a substrate transferring operation 602, a first pair of substrates 150 is transferred along the paths “A1” from the input conveyors 113 to the incoming conveyors 111.

Next, in a substrate loading operation 604, each of the incoming conveyors 111 loads the first pair of substrates 150 onto the processing nests 131 located in loading/unloading positions “1” and “3” as shown in FIG. 5A. In this configuration, each substrate 150 is transferred from the belts 116 to the processing nest 131 following the transfer path “A2”.

In a single inspection operation 606, each inspection system 200 may capture images of the substrate 150 positioned on the processing nest 131 in position “1” and “3” and send the images to the system controller 101 for analysis to determine the exact location and orientation of each substrate 150 on the respective processing nest 131. The location and orientation data of each substrate 150 on each processing nest 131 is subsequently used by the system controller 101 in conjunction with the respective first processing head 102 and/or mover 144 and/or second processing head 202, for precise positioning of the substrate 150 during a processing operation as subsequently described.

Additionally, each of the first pair of substrates 150 may be inspected by the inspection system 200 to assure that there are no broken, chipped, or cracked substrates 150 positioned on the processing nests 131.

Next, in a first processing nest moving operation 608, the processing nests 131 with the unprocessed substrates 150 disposed thereon are each moved inwardly from their respective loading positions “1” and “3” along path “A3” as shown in FIG. 5B.

In a second processing nest moving operation 610, the two processing nests 131 moved inwardly are moved substantially simultaneously along the paths “A4” via their respective movers 144 of the actuator assembly 140 as shown in FIG. 5B, whereas the two processing nests 131 in positions “2” and “4” under the two first processing heads 102 are moved along the paths “A5”, under the second processing head 202.

In this configuration, the processing nests 131 that were originally positioned in the loading/unloading positions “1” and “3” are moved along the paths “A3” and “A4” to the respective processing positions “2” and “4” via their respective movers 144.

Concurrently, the processing nests 131 that were originally positioned in the processing positions “2” and “4” are moved along the path “A5” to be positioned under the second processing head 202, via their respective mover.

Subsequently, an alignment operation 612 is performed, of which more will be said hereafter, to align the first processing heads 102 to the substrates 150 below to be processed, which are disposed on the processing nest 131, according to the data detected in the inspection operation 606.

Next, a first processing operation 614 is performed, by means of which a first layer of material is printed on the substrate 150 disposed under each first processing head 102.

Afterward, in a third processing nest moving operation 616, the processing nests 131 with the substrates 150 that are in positions “2” and “4” and have been processed there with the printing of a first layer, are moved along the path “A5” and positioned in a third processing position “5” under the second processing head 202 to perform a second processing operation 618, for example laser drying of the first layer of fresh print material. Simultaneously, the processing nests 131 previously positioned under the second processing head 202 in position “5” are moved along the path “A5” to be disposed in position “2” and “4” under a corresponding first processing head 102, in which the first processing operation 614 is repeated to print a second layer of print material on the substrate 150.

In a fourth moving operation 620, after having printed, in position “2” and “4”, the second layer on the processed substrates 150, the latter are again moved, along the path “A5” to position “5” under the second processing head 202, where the second processing operation 618 is repeated to perform the second process, in this case laser drying, also on the second layer of print material, while at the same time, the substrates 150 with the second layer of print material that are in position “5” are moved along the path “A6” and positioned in the respective loading/unloading positions “1” and “3” to free the second processing head 202 and continue along the production line as explained in more detail hereafter.

In a fifth operation 622, the processing nests 131 positioned inwardly from the loading/unloading positions “1” and “3” are moved outwardly along paths “A7” into the loading/unloading positions “1” and “3” via their respective movers 144 of the actuator assembly 140 as shown in FIG. 5C.

As we said, before the first processing operation 614 of the substrates 150 disposed on the processing nests 131 positioned in the processing positions “2” and “4” shown in FIG. 5C, said alignment operation 612 is performed, in which said substrates 150 are precisely aligned for a subsequent processing operation under the respective first processing head 102. In one embodiment, the location and orientation data of each substrate 150 on each respective processing nest 131 collected by the inspection system 200 in the inspection operation 606 is used by the system controller 101 to position and orient the components in the first processing head 102 to improve the accuracy of the subsequent process.

According to the invention, a single detection step is used to position and align the substrate 150 on the processing nest 131 and to position and orient the components in the first processing heads 102, without needing, after having performed the movement from the first processing head 102 to the second processing head 202 and vice versa, to detect again the position and alignment for the purposes of printing the second print layer by means of the first processing head 102.

This single detection of position and alignment is performed by the inspection system 200 for each substrate 150 to be processed when the substrate 150 still has to be processed and is substantially in position “1” and “3”. In the embodiment wherein the system 100 is a screen printing system, the location and orientation data may be used to position and orient the screen print components of the processing head 102 to improve the accuracy of the screen printing process.

In one embodiment, the location and orientation data collected by the inspection system 200 for each substrate 150 on each processing nest 131 in positions “1” and “3” is used by the system controller 101 to precisely position each processing nest 131 relative to the printing mask in each processing head 102 in the X-Y directions via the respective mover 144 and to angularly adjust the orientation of the print mask in the processing head 102 to a desired location and orientation relative to the substrate 150 positioned on the processing nest 131 using one or more of the actuators 105.

As mentioned above, the first processing operation 614, a process like screen printing or ink jet printing or the like, is performed on the first pair of substrates 150 precisely positioned in the processing positions “2” and “4” as shown in FIG. 5C.

Instead, the second processing operation 618, advantageously a drying process performed by exposing the substrate to a laser, is performed at position “5” by the second processing head 202 on the substrates 150 processed in positions “2” and “4”.

According to the characteristics of the laser and the sizes of the substrate, the laser could cover the whole substrate, or only a part of it.

In this case, the whole substrate can be dried by translating the processing nest 131 and/or the laser beam.

In particular, the power emitted by the laser, the scanning speed and the area exposed must be controlled so as to assure a uniform and repeatable drying without burning or damaging the printed material on the substrate. A laser with different characteristics could be used, on the contrary, for different operations, such as the etching of surface layers of the print substrate, etching of the substrate itself, or to perform a process on the layer deposited in the step prior to printing.

In one embodiment, the laser is one of those readily available on the market, for example a continuous wavelength laser, pulsed wavelength laser, power laser, wavelength laser, etc. . . .

The second process could also be drying using a UV lamp or a beam of electrons.

The second process could also be a traditional drying by means of exposure to infrared rays and/or hot air, in this case with the provision that the processing nest 131 is suitably made of materials resistant, or non-sensitive, to high temperatures, so as to avoid having to change the processing nest and so as to keep unchanged the location and orientation data detected in the inspection operation 606.

The first processing operation 614 is then repeated on the substrates 150 in positions “2” and “4” after the second process has been performed upon them in position “5”, in order to print a second layer of material above the first layer previously done.

The second processing operation 618 is finally repeated on the substrates 150 on which the second layer of material has been printed and which are moved from positions “2” and “4” and positioned in position “5”. It is clear that, according to the requirements of making more than two layers of print material, it may be possible to repeat the processing operations as above a desired number of times.

Using the laser drying technique, other drying techniques that do not require changing the processing nest, or using a processing nest that is not sensitive to the temperatures normally reached in traditional ovens is advantageous since it allows to keep the processed substrate 150 always on the same processing nest 131, thus using, as reference, only the location and orientation data detected once only by the inspection system 200 at the start of the processing cycle for the specific substrate 150.

In fact, with the present invention, the processing nest 131 is not damaged and it is therefore not necessary to move the substrate 150, thus allowing the orientation and position parameters detected upstream of the process to be used. On the contrary, drying or baking ovens used in known methods in combination with traditional processing nests, due to the sensitivity of the components of the traditional processing nest to the high temperatures that are reached inside them, entail changing the processing nest for the substrates 150 to be dried, thus losing, in practice, the location and orientation references originally detected.

In the case of possible subsequent processing operations that require great accuracy, as in the printing of multiple layers, this leads to the need to acquire new location and orientation data and to reset the possible subsequent processing heads with respect to the new data, with an obvious waste of time.

In this way, in some embodiments of the invention, it is possible to make a multiple print without ever removing the substrate from the processing nest on which it is positioned. This has the practical advantage of great accuracy. For example, in embodiments of the invention that perform screen printing, it is possible to print two or more times with the same print net, thus eliminating the inaccuracies due to two nets nominally identical but which, in practice, have differences.

In one embodiment, to increase system throughput, while the first processing operation 614 is being performed on a pair of substrates 150 respectively in positions “2” and “4”, the second processing operation 618 is also performed on a pair of substrates 150 already subjected to the first process.

In one embodiment, to increase system throughput, while the first processing operation 614 is being performed on a pair of substrates 150 respectively in positions “2” and “4”, operations 602-608 are repeated for a second pair of substrates 150. That is, a second pair of substrates 150 is first transferred from the input conveyors 113 to the incoming conveyors 111 in a second transfer operation 602. Each of the second pair of substrates 150 is loaded onto the processing nests 131 located in positions “1” and “3” in a further loading operation 604.

According to some embodiments, the feed of the second pair of substrates 150 is synchronized with the completion of the multiple processing of the first pair of substrates 150 fed under the first processing head 102, this also comprising the second process under the second processing head 202. According to one embodiment of the invention, while the first and the second pair of substrates 150 are subjected to the repetition of the first and second processes in sequence, being moved along the path “A5”, a third or following pair of substrates 150 is not yet moved from position “1” and “3” to position “2” and “4”, since this would cause a simultaneous presence of substrates under the first processing heads 102.

Other embodiments, on the contrary, can provide a simultaneous presence of substrates 150 to be processed belonging to different pairs of substrates under the first processing heads 102.

Other embodiments can provide that a substrate 150 processed in position “2” or “4” is moved and processed in position “5” and from here again moved to position “2” or “4”.

Alternatively, embodiments of the invention may provide that a substrate 150 processed in position “2” or “4” is moved and processed in position “5” and from here moved to the opposite position “4” or “2” respectively.

Here again, in steady state operation, processed substrates 150 are located on the processing nests 131, which are unloaded as the second pair of unprocessed substrates 150 are loaded. Each substrate of the second pair of substrates 150 is inspected via the inspection system 200 in another inspection operation 606. Then, each of the processing nests 131 supporting the second pair of substrates 150 is moved inwardly along the path “A3” in another moving operation 608.

In a sixth processing nest moving operation 624, the processing nests 131 supporting the processed substrates 150 after the repetition of the desired number of times of the sequence of first processing operations 614 and second processing operations 618, and positioned in the loading/unloading positions “1” and “3”, are moved outwardly along paths “A8” (FIG. 5C).

In an unloading operation 626, each of the first pair of processed substrates 150 supported by the processing nests 131 located in the loading/unloading positions “1” and “3” is unloaded onto the respective outgoing conveyor 112 as shown in FIG. 5C. In this configuration, each processed substrate 150 is transferred from the processing nest 131 to the belts 116 of the outgoing conveyors 112 following the path “A8”. Concurrently, unprocessed substrates 150 are loaded onto the processing nests 131 as previously described in loading operation 604.

Finally, in a substrate transferring operation 628, the first pair of processed substrates 150 is transferred along the paths “A9” from the outgoing conveyors 112 to the exit conveyors 114 as shown in FIG. 5C.

It is clear that, although the above operational sequence 600 provides, as described above in one embodiment of the invention, to perform two first processes and two second processes, it cannot be excluded that it also comes within the spirit of the invention to provide third or other intermediate processes, either upstream or downstream or in combination with these, of a similar or different type, both with respect to the first and the second process, consequently adding, adapting or varying the movements of the processing nest between the various processing heads.

Moreover, in steady state operation, the operations 602-628 of the operating sequence 600 may be continually repeated for continuous processing of substrates 150 in a production line environment. The number and sequence of operations illustrated in FIG. 4 are not intended to limit the scope of the invention described herein, since one or more operations can be deleted and/or reordered without deviating from the basic scope of the invention described herein. Additionally, the schematic representation of the operations shown in FIGS. 5A-5C is not intended to limit the scope of the invention described, since the operations need not be completed in a sequential fashion as pictorially shown, and two or more of the operations can be completed simultaneously.

In addition to the above described movement of each substrate 150 between the loading/unloading positions “1” and “3” and the processing positions “2” and “4”, a number of other alternative transfer paths are embodied within the scope of the present invention. In one embodiment, the processing nests 131 that are initially located in positions “1” and “2” continually exchange positions in the loading, processing, and unloading operations. Concurrently, the processing nests 131 that are initially located in positions “3” and “4” continually exchange positions in the loading, processing, and unloading operations.

In another embodiment, the processing nest 131 that is initially located in the loading/unloading position “1” moves to printing position “2” and position “5” and then back to the loading/unloading position “1”. Concurrently, the processing nest 131 that is initially located in the loading/unloading position “3” moves to processing position “4” and to position “5” and then back to the loading/unloading position “3.” These movements are continually repeated throughout the processing sequence.

In yet another embodiment, the processing nest 131 that is initially located in the loading/unloading position “1” moves to processing position “2” and to position “5” and then moves to the loading/unloading position “3” as previously described. The processing nest 131 then moves back to processing position “2” and then moves back to the loading/unloading position “1”. Concurrently, the processing nest 131 that is initially located in the loading/unloading position “3” moves to processing position “4” and to “5” and then moves to the loading/unloading position “1”. The processing nest 131 then moves back to processing position “4” and then moves back to the loading/unloading position “3”. These movements are continually repeated throughout the processing sequence.

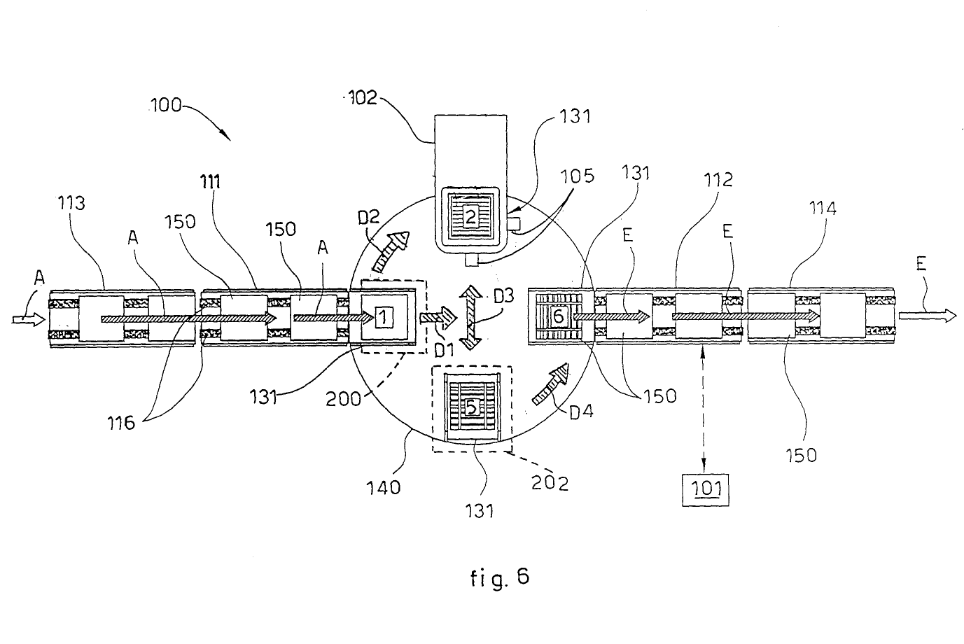

Embodiments of the present invention provide a minimal configuration of the system 100 to a single production line which could comprise, as shown for example in FIG. 6: a single input conveyor 113; a single incoming conveyor 111 to position a substrate 150 on a processing nest 131 in a first loading position “1”; a first processing head 102 in a second processing position “2” which performs a first process, for example screen printing; a second processing head 202 in a third processing position “5” which performs a second process, different from the first, for example laser drying, or equivalent technology as discussed above, on the substrate 150; an actuator assembly 140 which moves the processing nest 131 with the relative substrate 150 from the first position “1” to the second position “2”, between the second position “2” and the third position “5”, according to a desired number of repetitions, and from position “5” to a fourth unloading or exit position “6” wherein the substrate 150 that has undergone the whole processing cycle of screen printing is deposited on a processing nest 131 which is directed, as shown by arrow E, to a single outgoing conveyor 112 and a following exit conveyor 114.

The actuator assembly 140 that performs the passage from the first processing head 102 to the second processing head 202 can be made for example via a mover 144 as in FIG. 3.

Otherwise, the actuator assembly 140 can be configured as a rotary table as described in the Italian patent application UD2009A000119 in the name of the present Applicant, and incorporated here entirely as a reference.

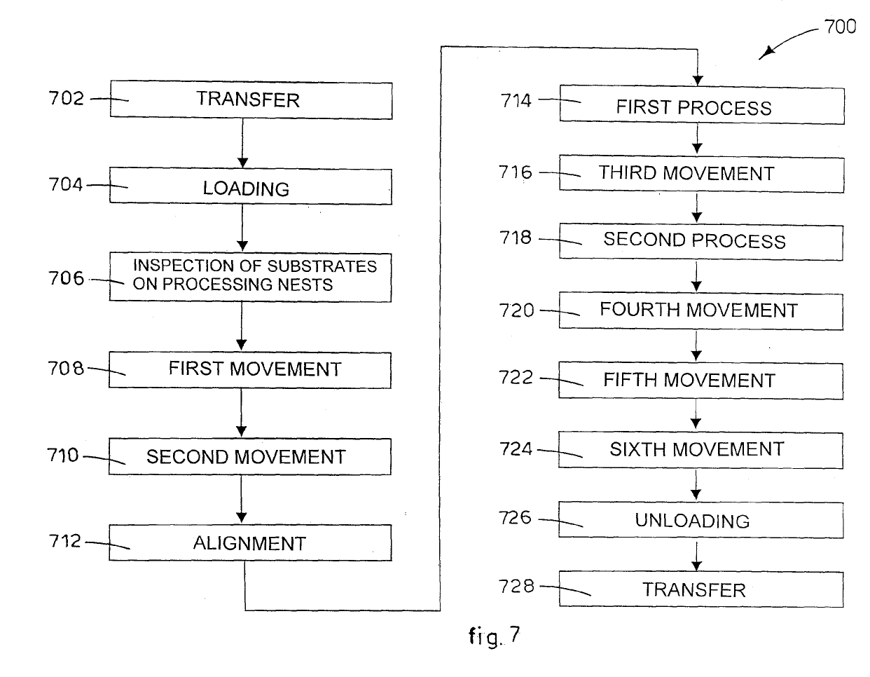

In the solution shown in FIG. 6 and in the relative operating sequence 700 in FIG. 7, a single inspection operation is provided, carried out via the inspection system 200, totally analogous to what we have already described, which detects once only, for each substrate 150 to be processed, the location and orientation data of the substrate 150 on the processing nest 131 in the position “1” in FIG. 6. This data is used by the system controller 101 to refer and align the reciprocal position of the substrate 150 to be processed and the first processing head 102, both in the course of making the first layer of material to be printed, and also in the course of the one or more subsequent makings of multiple layers after the first. In some embodiments, the refer and alignment operation is performed by means of the actuators 105 of the processing head 102 only on the basis of the data detected, in a single inspection operation in the first position “1”, by the inspection system 200. According to the invention, in the course of the processing cycle, for example first screen printing of the layer of material, first drying, second screen printing, second drying and so on, the substrate 150 is never moved from the processing nest 131 on which it is deposited. This is also, advantageously, as we said before, thanks to the choice of a drying unit to perform the second process, which does not need the processing nest 131 to be changed.

There is therefore no need, after each second process under the second processing head 202, to again detect the location and orientation of the substrate 150, since this has not been moved with respect to its processing nest 131.

In the specific embodiment shown in FIG. 6, the operating sequence 700 of the method according to the invention, shown schematically in FIG. 7, provides a substrate transfer operation 702 wherein the substrate 150 is transferred from the input conveyor 113 to the incoming conveyor 111 along the path indicated by the arrow “A” in FIG. 6.

Next, there is a first loading operation 704 by means of which the substrate 150 is deposited on the processing nest 131 in position “1”. In this position “1” we have an inspection operation 706, by means of which said inspection system 200 detects location and orientation of the substrate 150 to be processed on the processing nest 131 in position “1” and transmits this data to the system controller 101 which uses them to set and adjust the reciprocal position of the substrate 150 and at least the first processing head 102, in the same way as in the operating sequence 600.

Subsequently, by means of a first moving operation 708, along path “D1”, the processing nest 131 with the substrate 150 to be processed is moved inwardly, for example via a mover 144 as in FIG. 3, with respect to the loading position “1”.

A second moving operation 710 moves the processing nest 131 with the substrate 150 under the first processing head 102, following the path “D2” where, in position “2”, an alignment operation 712 is performed, wherein the first processing head 102 is adjusted according to the data captured in the single inspection operation 706 so as to have the correct printing alignment with the substrate 150 below. Next, again in position “2”, a first processing operation 714 is performed, for example screen printing of a first layer of print material on the substrate 150.

Next, a third moving operation 716 provides to move, following path “D3”, the processing nest 131 with the processed substrate 150 under the second processing head 202 in position “5”, for example under a laser drying unit, where a second processing operation 718 is performed on the substrate 150, for example laser drying. With the third moving operation 716 the processing nest 131 is also moved with the substrate 150, subjected to the second process, along the path “D3” from position “5” under the second processing head 202 again to position “2” under the first processing head 102 where both the alignment operation 712 is repeated, and also, afterward, the first processing operation 714 to print a second layer of material, above the first layer of already printed material.

Afterward, a fourth moving operation 720 provides to move, along path “D3”, the processing nest 131 with the processed substrate 150 from position “2” again to position “5” in FIG. 6, where the second processing operation 718 is repeated under the second processing head 202 and simultaneously to move inwardly with respect to the fourth position “6” the processing nest 131 with the substrate 150 already subjected to the repetition of the second process.

Then there will be a fifth moving operation 722 to move the processing nests 131 positioned inwardly with respect to the fourth position “6” outwardly along the path “D4” to the fourth position “6”.

In a sixth moving operation 724, the processing nests 131 supporting the processed substrates 150 in the fourth position “6” are moved outwardly as shown by arrow “E”.

Afterward there is an unloading operation 726 wherein each processed substrate 150 supported by the processing nest 131 is unloaded onto the respective outgoing conveyor 112. In this configuration, each processed substrate 150 is transferred from the processing nest 131 to the belts 116 of the incoming conveyor 111 following path “E”. At the same time the unprocessed substrates 150 are loaded onto the processing nests 131 as previously described in the loading operation 704.

Finally, in a substrate transfer operation 728, the processed substrate 150 is transferred along paths “E” from the outgoing conveyor 112 toward the exit conveyors 114 as shown in FIG. 6. In this configuration, the controller 101 is used to coordinate the motion of the belts 116 and drive the actuators (not shown) in each outgoing conveyor 112 and exit conveyor 114 so that the substrates 150 are reliably transferred between these automated components.

It is clear that, although the above operational sequence 700 provides, as described above in one embodiment of the invention, to perform two first processes and two second processes, it cannot be excluded that it also comes within the spirit of the invention to provide third or other intermediate processes, either upstream or downstream or in combination with these, of a similar or different type, both with respect to the first and the second process, consequently adding, adapting or varying the movements of the processing nest between the various processing heads.

Furthermore, in steady state operation, the operations 702-728 of the operating sequence 700 are continually repeated for continuous processing of substrates 150 in a production line environment. The number and sequence of operations illustrated in FIG. 7 are not intended to limit the scope of the invention described herein, since one or more operations can be deleted and/or reordered without deviating from the basic scope of the invention described herein.

While the foregoing is directed to embodiments of the present invention, other and further embodiments of the invention may be devised without departing from the basic scope thereof, and the scope thereof is determined by the claims that follow.

1-20. (canceled)

21. An apparatus for processing a substrate, comprising:
an actuator assembly configured to position a processing nest in a first position, a second position and a third position, wherein the first, second and third positions are each disposed on a first plane defined within the apparatus;
an incoming conveyor configured to transfer the substrate and dispose the substrate onto a supporting surface of the processing nest when the processing nest is disposed in the first position;
an inspection system disposed in the first position, and positioned to detect the location and orientation of the substrate supported on the supporting surface of the processing nest;
one or more first processing heads disposed in the second position, and configured to perform a first process on the substrate when the processing nest is moved to the second position by the actuator assembly; and
one or more second processing heads disposed in the third position, and configured to perform a second process, which is different from the first process, on the substrate when the processing nest is moved to the third position by the actuator assembly.

22. The apparatus of claim 21, wherein each of the one or more first processing heads disposed in the second position comprise at least an actuator configured to align the position of the first processing head to the substrate supported on the supporting surface of the processing nest using the location and orientation data detected by the inspection system disposed in the first position.

23. The apparatus of claim 21, wherein the one or more first processing heads comprise a processing head selected from the group consisting of a screen printing head and an ink jet printing head.

24. The apparatus of claim 21, wherein the one or more second processing heads comprises a processing head selected from the group consisting of a UV light drying unit, an electron beam drying unit, a laser drying unit, a laser heating unit, an etching unit, a laser etching unit and combinations thereof.

25. The apparatus of claim 21, further comprising an outgoing conveyor configured to receive the substrate from the supporting surface of the processing nest when the substrate is disposed in the first position.

26. The apparatus of claim 21, wherein the actuator assembly is further configured to move the processing nest to a fourth position that is disposed on the first plane, and the apparatus further comprises an outgoing conveyor connected to the actuator assembly and configured to receive the substrate from the supporting surface of the processing nest when the substrate is disposed in the fourth position.

27. The apparatus of claim 26, wherein the actuator assembly is configured to transfer the processing nest from the third position to the fourth position without passing through the second position nor the first position.

28. The apparatus of claim 21, wherein the actuator assembly is configured to transfer the processing nest between the second position and the third position, or between the third position and the second position, without passing through the first position.

29. The apparatus of claim 21, wherein the actuator assembly is connected to two parallel processing lines.

30. The apparatus of claim 29, wherein each processing line comprises one incoming conveyor and one outgoing conveyor.

31. The apparatus of claim 21, wherein the actuator assembly comprises a stator and one or more movers.

32. The apparatus of claim 31, wherein the one or more movers comprises an armature coil for receiving an electric signal.

33. The apparatus of claim 31, wherein the stator comprises a plurality of permanent magnets.

34. A method for processing a substrate in an apparatus, comprising:
disposing a substrate on a processing nest that is positioned in a first position within the apparatus;
detecting the location and orientation of the substrate disposed on the processing nest when the processing nest is positioned in the first position;
transferring the processing nest and the substrate from the first position to a second position using an actuator assembly, wherein the processing nest positioned in the second position is disposed under a first processing head;
aligning the first processing head to the substrate disposed on the processing nest when the processing nest is positioned in the second position using the location and orientation data detected when the processing nest is positioned in the first position;
performing a first process on the substrate when the processing nest is positioned in the second position;
transferring the processing nest and the substrate from the second position to a third position using the actuator assembly, wherein the processing nest positioned in the third position is disposed under a second processing head;
aligning the second processing head to the substrate disposed on the processing nest when the processing nest is positioned in the third position using the location and orientation data detected when the processing nest is positioned in the first position;
performing a second process, different from the first process, on the substrate when the processing nest is positioned in the third position under the second processing head; and
transferring the processing nest and the substrate from the third position to the first position without passing through the second position.

35. The method of claim 34, wherein the substrate disposed on the processing nest is moved repeatedly between the second position and the third position, where the first process and the second process are performed, according to a desired number of repetitions, without passing through the first position.

36. The method of claim 34, wherein the first process is selected from a group consisting of a screen printing process and an ink jet printing process.

37. The method of claim 34, wherein the second process is selected from a group consisting of an UV light drying operation, an electron beam drying operation, a laser drying operation, a laser heating operation, an etching operation of surface layers, a laser etching operation and combinations thereof.

38. The method of claim 34, further comprising moving the processing nest from the third position on the actuator assembly to a fourth exit position, different from the first position, without passing through the second position.

39. The method of claim 34, further comprising:
receiving the substrate from the processing nest onto an outgoing conveyor connected to the actuator assembly when the substrate is processed and disposed in the first position.

40. The method of claim 34, further comprising:
moving the processing nest to a fourth position using the actuator assembly; and
receiving the substrate from the processing nest onto an outgoing conveyor connected to the actuator assembly when the substrate is processed and disposed in the fourth position.
